(19) United States
(12) Patent Application Publication
(10) Pub. No.: US 2014/0091222 A1
(43) Pub. Date: Apr. 3, 2014

(54) Neutron Detection Apparatus Including A Gadolinium Yttrium Gallium Aluminum Garnet And Methods To Use Same

(71) Applicants: Xiaofeng Peng, Shanghai (CN); Qiwei Chen, Shanghai (CN)

(72) Inventors: Xiaofeng Peng, Shanghai (CN); Qiwei Chen, Shanghai (CN)

(21) Appl. No.: 14/026,190

(22) Filed: Sep. 13, 2013

Related U.S. Application Data
(60) Provisional application No. 61/745,882, filed on Dec. 26, 2012.

(30) Foreign Application Priority Data
Sep. 28, 2012 (CN) 201210371081.7

(51) Int. Cl. G01T 3/06; B29C 43/00; G01T 1/20

(52) U.S. Cl. CPC G01T 3/06; G01T 1/2006; B29C 43/006
USPC 250/361 R; 250/390.11; 264/614

(57) ABSTRACT

A neutron detection apparatus can include a scintillator having a formula of Gd₃₍₁₋ₓ₎Y₃ₐAl_{5(1-y)}Ga_{5y}O₁₂. In an embodiment, x is at least approximately 0.05 and no greater than approximately 0.5 and y is at least approximately 0.05 and no greater than approximately 0.95. The scintillator can be capable of emitting scintillating light in response to interactions with neutrons. The neutron detection apparatus can also include a photosensor optically coupled to the scintillator.

### CROSS-REFERENCE TO RELATED APPLICATION

This application claims priority to Chinese Application No. 201210371081.7, entitled “A Neutron Detection Apparatus Including A Gadolinium Yttrium Gallium Aluminum Garnet And Methods To Use Same”, by Peng et al., filed Sep. 28, 2012, which is assigned to the current assignee hereof and incorporated herein by reference in its entirety. This application further claims priority under 35 U.S.C. §119(e) to U.S. Patent Application No. 61/745,882 entitled “A Neutron Detection Apparatus Including A Gadolinium Yttrium Gallium Aluminum Garnet And Methods To Use Same,” by Peng et al., filed Dec. 26, 2012, which is assigned to the current assignee hereof and incorporated herein by reference in its entirety.

### FIELD OF THE DISCLOSURE

The present disclosure is directed to a neutron detection apparatus including a gadolinium yttrium gallium aluminum garnet, and methods for forming the same.

### BACKGROUND

Scintillator-based detectors are used in a variety of applications, including research in nuclear physics, oil exploration, field spectroscopy, container and baggage scanning, and medical diagnostics. When a scintillator of the scintillator-based detector is exposed to particle radiation, the scintillator absorbs energy of incoming particles and scintillates, emitting the absorbed energy in the form of photons. For example, a neutron detector can emit photons after absorbing a neutron. A typical neutron detector can include neutron sensing materials, such as ³He, ⁶Li, ¹⁰B, or ¹⁵⁷Gd. The neutron sensing materials can interact with neutrons to produce secondary particles that interact with the scintillator material to produce photons. The photons can be detected and converted to electrical pulses that can be processed by electronic devices and registered as counts that are transmitted to analyzing equipment. Further improvements of scintillator-based neutron detectors are desired.

### CONTENTS OF THE INVENTION

Embodiments may be in accordance with any one or more of the items as listed below that illustrate and do not limit the scope of the appended claims.

Item 1. A neutron detection apparatus, comprising: a scintillator having a formula of Gd₃₍₁₋ₓ₎Y₃ₓAl_{5(1-y)}Ga_{5y}O₁₂, wherein x is at least approximately 0.05 and no greater than approximately 0.5 and y is at least approximately 0.05 and no greater than approximately 0.95, wherein the scintillator is capable of emitting scintillating light in response to interactions with neutrons; and a photosensor optically coupled to the scintillator.

Item 2. A process comprising: receiving neutron radiation at a neutron detection apparatus, the neutron detection apparatus comprising: a scintillator having a formula of Gd₃₍₁₋ₓ₎Y₃ₓAl_{5(1-y)}Ga_{5y}O₁₂, wherein x is at least approximately 0.05 and no greater than approximately 0.5 and y is at least approximately 0.05 and no greater than approximately 0.95; and a photosensor optically coupled to the scintillator; emitting scintillating light in response to capturing a neutron by the scintillator; and generating an electronic pulse at the photosensor in response to receiving the scintillating light or a derivation thereof.

Item 3. The process as recited in item 2, further comprising converting a fast neutron to a thermal neutron.

Item 4. The neutron detection apparatus or the process as recited in any one of items 1 to 3, wherein x is at least approximately 0.09, at least approximately 0.18, at least approximately 0.26 or at least approximately 0.38.

Item 5. The neutron detection apparatus or the process as recited in any one of the preceding items, wherein x is no greater than approximately 0.44, no greater than approximately 0.32, no greater than approximately 0.21, or no greater than approximately 0.12.

Item 6. The neutron detection apparatus or the process as recited in any one of the preceding items, wherein y is at least approximately 0.15, at least approximately 0.36, at least approximately 0.58, or at least approximately 0.76.

Item 7. The neutron detection apparatus or the process as recited in any one of the preceding items, wherein y is no greater than approximately 0.85, no greater than approximately 0.64, no greater than approximately 0.46, or no greater than approximately 0.27.

Item 8. The neutron detection apparatus or the process as recited in any one of the preceding items, wherein the scintillator comprises an activator including Ce, Pr, Tb, or a combination thereof.

Item 9. The neutron detection apparatus or the process as recited in item 8, wherein the scintillator includes at least approximately 100 atomic parts per million (ppm) Ce, at least approximately 300 atomic ppm Ce, at least approximately 600 atomic ppm Ce, or at least approximately 1100 atomic ppm Ce.

Item 10. The neutron detection apparatus or the process as recited in item 8, wherein the scintillator includes no greater than approximately 1.5 atomic % Ce, no greater than approximately 0.8 atomic % Ce, or no greater than approximately 0.1 atomic % Ce.

Item 11. The neutron detection apparatus or the process as recited in any one of items 8 to 10, wherein the activator is substituted for part of Gd, part of Y, or both part of Gd and Y.

Item 12. The neutron detection apparatus or the process as recited in any one of the preceding items, wherein the neutron detection apparatus further comprises an optical coupling material disposed between the scintillator and the photosensor.

Item 13. The neutron detection apparatus or the process as recited in item 12, wherein the optical coupling material comprises an organic polymer.

Item 14. The neutron detection apparatus or the process as recited in item 13, wherein the organic polymer includes a silicone rubber, an epoxy, a plastic, or any combination thereof.

Item 15. The neutron detection apparatus or the process as recited in any one of the preceding items, wherein the photosensor comprises a photodiode, a photomultiplier tube, a silicon photomultiplier, an avalanche photodiode, a hybrid photomultiplier tube, or any combination thereof.

Item 16. The neutron detection apparatus or the process as recited in any one of the preceding items, wherein the neutron detection apparatus comprises a neutron moderator to convert fast neutrons to thermal neutrons.

Item 17. The neutron detection apparatus or the process as recited in item 16, wherein the neutron moderator includes a hydrocarbon.

Item 18. The neutron detection apparatus or the process as recited in item 17, wherein the hydrocarbon includes a polyolefin or a polyacrylate.

Item 19. The neutron detection apparatus or the process as recited in any one of the preceding items, wherein the neutron detection apparatus comprises a wavelength shifter to shift a wavelength of the scintillating light to a derivative light that has a longer wavelength as compared to the wavelength of the scintillating light.

Item 20. The neutron detection apparatus or the process as recited in any one of the preceding items, wherein the neutron detection apparatus comprises a plurality of layers comprising the scintillator.

Item 21. The neutron detection apparatus or the process as recited in any one of the preceding items, wherein the scintillating light has an emission maximum that is at least approximately 350 nm, at least approximately 390 nm, at least approximately 420 nm, at least approximately 450 nm, at least approximately 485 nm, or at least approximately 540 nm.

Item 22. The neutron detection apparatus or the process as recited in any one of items 1 to 20, wherein the scintillating light has an emission maximum that is no greater than approximately 710 nm, no greater than approximately 605 nm, no greater than approximately 500 nm, no greater than approximately 470 nm, or no greater than approximately 430 nm.

Item 23. The neutron detection apparatus or the process as recited in any one of the preceding items, wherein the scintillator has a porosity that is no greater than approximately 10 vol %, no greater than approximately 7 vol %, no greater than approximately 4 vol %, or no greater than approximately 1 vol %.

Item 24. The neutron detection apparatus or the process as recited in any one of the preceding items, wherein the photosensor has a quantum efficiency of at least approximately 8%, at least approximately 18%, at least approximately 24%, or at least approximately 32%.

Item 25. The neutron detection apparatus or the process as recited in any one of items 1 to 23, wherein the photosensor has a quantum efficiency of no greater than approximately 48%, no greater than approximately 41%, no greater than approximately 36%, or no greater than approximately 28%.

Item 26. The neutron detection apparatus or the process as recited in any one of the preceding items, wherein the scintillator includes a plurality of phases.

Item 27. The neutron detection apparatus or the process as recited in item 26, wherein the plurality of phases includes a ceramic phase and at least one non-crystalline secondary phase.

Item 28. The neutron detection apparatus or the process as recited in item 27, wherein the at least one secondary phase includes an amorphous phase.

Item 29. The neutron detection apparatus or the process as recited in any one of items 1 to 25, wherein the scintillator includes a single phase.

Item 30. The neutron detection apparatus or the process as recited in any one of the preceding items, wherein the photosensor is configured to detect particular scintillating light having an emission maximum of at least approximately 500 nm.

Item 31. The neutron detection apparatus as recited in item 1, further comprising electronics configured to utilize pulse-shape discrimination to differentiate gamma rays captured by the scintillator from neutrons captured by the scintillator.

Item 32. A process comprising: forming one or more powders of starting materials; mixing the one or more starting materials to form a mixture; forming the mixture into a green body; and heat treating the green body to form a scintillator having a formula of Gd₃₍₁₋ₓ₎Y₃ₓAl_{5(1-y)}Ga_{5y}O₁₂, wherein x is at least approximately 0.05 and no greater than approximately 0.5 and y is at least approximately 0.05 and no greater than approximately 0.95, and wherein the scintillator is capable of emitting scintillating light in response to interactions with neutrons.

Item 33. The process as recited in item 32, wherein the one or more powders of starting materials are formed via a solution combustion process or a precipitation process.

Item 34. The process as recited in item 32 or 33, wherein particles of the one or more powders of the starting materials have a specific surface area of at least approximately 7.0 m²/g, at least approximately 13.1 m²/g, or at least approximately 18.4 m²/g.

Item 35. The process as recited in item 32 or 33, wherein particles of the one or more powders of the starting materials are no greater than approximately 21.9 m²/g, no greater than approximately 19.4 m²/g, or no greater than approximately 17.7 m²/g.

Item 36. An X-ray detection apparatus, comprising: a scintillator having a formula of Gd₃₍₁₋ₓ₎Y₃ₓAl_{5(1-y)}Ga_{5y}O₁₂, wherein x is at least approximately 0.05 and no greater than approximately 0.5 and y is at least approximately 0.05 and no greater than approximately 0.95, wherein the scintillator is capable of emitting scintillating light in response to interactions with X-rays; and a photosensor optically coupled to the scintillator.

### BRIEF DESCRIPTION OF THE DRAWINGS

Embodiments are illustrated by way of example and are not limited in the accompanying figures.

FIG. 1 is a diagram illustrating a particular embodiment of a neutron detection apparatus.

FIG. 2 is a flow diagram illustrating a process to detect neutrons with a scintillating material.

FIG. 3 is a flow diagram illustrating a process to make a scintillator according to an embodiment.

FIG. 4 is a scanning electron microscope (SEM) image of a (Gd_{0.5}, Y_{0.5})₂O₃: Ce powder.

FIG. 5 is an SEM image of an Al₂O₃ powder.

FIG. 6 is an SEM image of a Ga₂O₃ powder precipitated using an ammonia water solution.

FIG. 7 is an SEM image of a Ga₂O₃ powder precipitated using an ammonium hydrogen carbonate solution.

FIG. 8 is an image of a number of samples of a scintillator having the formula Gd₃₍₁₋ₓ₎Y₃ₓAl_{5(1-y)}Ga_{5y}O₁₂:Ce.

The use of the same reference symbols in different drawings indicates similar or identical items.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or other features that are inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the embodiments of the disclosure. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this disclosure belongs. The materials, methods, and examples are illustrative only and not intended to be limiting. To the extent not described herein, many details regarding specific materials and processing acts are conventional and may be found in textbooks and other sources within the scintillation and radiation detection arts.

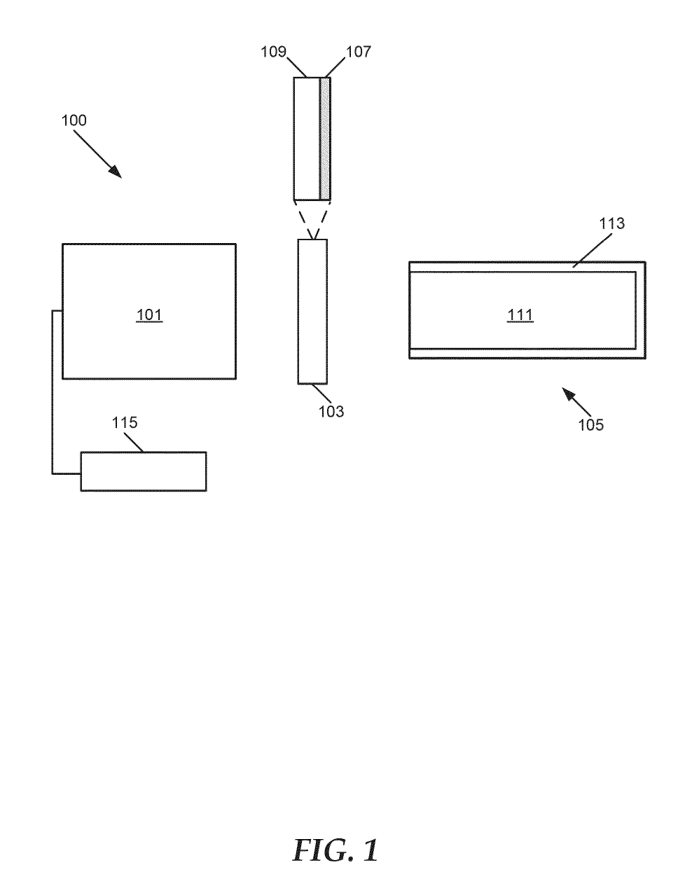

FIG. 1 is a diagram illustrating a particular embodiment of a neutron detection apparatus 100. The neutron detection apparatus 100 can include a well logging apparatus, a security inspection apparatus, a port of entry detection apparatus, or another suitable apparatus for detecting neutrons (e.g. a neutron detection apparatus in a nuclear reactor facility). In addition, the neutron detection apparatus 100 can include a photosensor 101, an optical interface 103, and a scintillation device 105.

The photosensor 101 can be a photodiode, a photomultiplier tube (“PMT”), a silicon photomultiplier tube (“SiPM”), an avalanche photodiode (“APD”), a hybrid PMT, or any combination thereof. In an embodiment, the photosensor 101 can be configured to detect particular scintillating light emitted by the scintillation device 105 or light derived from such scintillating light. In a particular embodiment, the photosensor 101 can be configured to detect scintillating light or derivative light. Furthermore, although one photosensor 101 is illustrated in FIG. 1, the neutron detection apparatus 100 can include a number of photosensors, such as an array of photosensors.

The optical interface 103 can comprise an optical coupling material 107 disposed between the photosensor 101 and the scintillation device 105. In an embodiment, the optical coupling material 107 can include an organic polymer or another suitable optical coupling material. For example, the optical interface 103 can include a silicone rubber, an epoxy, a plastic, or any combination thereof. In an additional embodiment, the optical interface 103 can include one or more layers of the optical coupling material 107.

The optical interface 103 can also include a window 109 that can be optically coupled to the photosensor 101 and the scintillation device 105. In the illustrative embodiment of FIG. 1, the window 109 is disposed between the optical coupling material 107 and the photosensor 101. In a particular embodiment, the window 109 can include quartz or sapphire. Although the photosensor 101, the optical interface 103, and the scintillation device 105 are illustrated separate from each other, the photosensor 101 and the scintillation device 105 can each be adapted to be coupled to the optical interface 103, with the optical interface 103 disposed between the photosensor 101 and the scintillation device 105. In other embodiments, the optical interface 103 may not include the window 109.

The scintillation device 105 can also include a scintillation material 111 and a reflector 113 disposed along one or more sides of the scintillation material 111. In the illustrative embodiment of FIG. 1, the scintillation material 111 is substantially surrounded by the reflector 113. In a particular embodiment, the reflector 113 can include a metal foil, polytetrafluoroethylene (PTFE) or another suitable material capable of reflecting light emitted by the scintillation material 111. The reflector 113 can reflect photons back into the scintillation material 111 to be transmitted to the photosensor 101 via the side of the scintillation device 105 adjacent to the optical interface.

In an embodiment, the neutron detection apparatus 100 can include more components or fewer components than those shown in FIG. 1. For example, the scintillation device 105 can include one or more shock absorbing members, one or more stabilization mechanisms (e.g. one or more springs), a housing, or any combination thereof. The neutron detection apparatus 100 can also include a wavelength shifter to shift a wavelength of scintillating light from the scintillation material 111 to the derivative light that has a longer wavelength as compared to the scintillating light. In addition, the neutron detection apparatus 100 can comprise an optical filter material disposed between the scintillation device 105 and the photosensor 101. The optical filter material can filter out certain wavelengths of scintillating light, such that only particular wavelengths of scintillating light are provided to the photosensor 101.

The scintillation material 111 can include a scintillator and one or more additional materials. In an embodiment, the scintillator can be a polycrystalline material having a formula of Gd₃₍₁₋ₓ₎Y₃ₓAl_{5(1-y)}Ga_{5y}O₁₂. In a particular embodiment, x can be at least approximately 0.05 and no greater than approximately 0.5 and y can be at least approximately 0.05 and no greater than approximately 0.95. Additionally, in one embodiment, x can be at least approximately 0.09, at least approximately 0.18, at least approximately 0.26 or at least approximately 0.38. In another embodiment, x may be no greater than approximately 0.44, no greater than approximately 0.32, no greater than approximately 0.21, or no greater than approximately 0.12. Further, y can be at least approximately 0.15, at least approximately 0.36, at least approximately 0.58, or at least approximately 0.76. In one embodiment, y may also be no greater than approximately 0.85, no greater than approximately 0.66, no greater than approximately 0.46, or no greater than approximately 0.27. In a particular illustrative embodiment, x can be approximately 0.5. In another particular illustrative embodiment, x can be 0 or x can indicate trace amounts of yttrium. In an additional illustrative embodiment, y may be no greater than approximately 0.66. In a further embodiment, the scintillation material 111 can include a plurality of layers comprising the scintillator.

The scintillator can also include an activator. In an embodiment, the activator can include Ce, Pr, Tb, or another suitable element capable of being in a +3 or +4 valence state. Additionally, the activator can be substituted for a portion of the Gd of the scintillator, a portion of the Y of the scintillator, or both. In a particular embodiment, the activator can include Ce and the scintillator can include at least approximately 100 atomic parts per million (ppm) Ce, at least approximately 300 atomic ppm Ce, at least approximately 600 atomic ppm Ce, or at least approximately 1100 atomic ppm Ce. In another embodiment, the scintillator may include no greater than approximately 1.5 atomic % Ce, no greater than approximately 0.8 atomic % Ce, or no greater than approximately 0.1 atomic % Ce.

The scintillator can have a porosity that is no greater than approximately 10 vol %, no greater than approximately 7 vol %, no greater than approximately 4 vol %, or no greater than approximately 1 vol %. Additionally, the scintillator can include a plurality of phases. In one embodiment, the plurality of phases can include a ceramic phase and at least one non-crystalline secondary phase. In a particular embodiment, the at least one secondary phase can include an amorphous phase. For example, the at least one secondary phase can include a phase having SiO₂. In an alternative embodiment, the scintillator can include a single phase.

In an embodiment, the scintillation material 111 can include a neutron sensing material. The neutron sensing material can include ¹⁵⁷Gd. In a particular embodiment, at least a portion of the neutron sensing material can be separate from the scintillator. For example, the scintillation material 111 can include a number of layers with a portion of the layers comprising the scintillator and another portion of the layers comprising a neutron sensing material.

The scintillation material 111 can also include a neutron moderator to convert fast neutrons to thermal neutrons. The conversion of fast neutrons to thermal neutrons can enhance the detection of neutrons by the neutron detection apparatus 100. In an embodiment, the neutron moderator can include a hydrocarbon. In a particular embodiment, the hydrocarbon can include a polyolefin or a polyacrylate, such as polymethylmethacrylate. In another embodiment, the hydrocarbon can include a polyethylene, such as a high density polyethylene. In a further embodiment, the hydrocarbon can include a polypropylene, such as a high density polypropylene.

The photosensor 101 can receive photons of scintillating light emitted by the scintillation material 111. In a particular embodiment, the photosensor 101 can receive photons of scintillating light when the scintillation material 111 is exposed to secondary particles produced when neutron sensing material of the scintillation material 111 is exposed to neutrons. When the photosensor 101 receives photons from the scintillation device 105, the photosensor 101 can produce electrical pulses based on numbers of photons received from the scintillation device 105. The photosensor 101 may provide the electrical pulses to electronics 115 that are electrically coupled to the photosensor 101.

In a particular embodiment, the photosensor 101 can have a quantum efficiency of at least approximately 8%, at least approximately 18%, at least approximately 24%, or at least approximately 32%. Additionally, the photosensor 101 may have a quantum efficiency of no greater than approximately 48%, no greater than approximately 41%, no greater than approximately 36%, or no greater than approximately 28%. In an embodiment, the quantum efficiency can be measured at a particular wavelength or at a particular range of wavelengths. For example, the quantum efficiency can be measured in one embodiment at a wavelength of approximately 550 nm.

In an embodiment, the scintillating light emitted by the scintillation material 111 can have an emission maximum that is at least approximately 350 nm, at least approximately 390 nm, at least approximately 460 nm, at least approximately 485 nm, or at least approximately 540 nm. In another embodiment, the scintillating light emitted by the scintillation material 111 may have an emission maximum no greater than approximately 710 nm, no greater than approximately 605 nm, no greater than approximately 500 nm, no greater than approximately 470 nm, or no greater than approximately 430 nm.

In an embodiment, the photosensor 101 can be selected to match the emission maximum of the scintillating light or a derivative thereof. For example, materials of the photosensor 101, a type of the photosensor 101, or both, can cause the photosensor 101 to be sensitive to particular wavelengths of radiation. Thus, in order to provide a suitable quantum efficiency, a particular photosensor 101 can be included in the neutron detection apparatus 100 based on wavelengths of scintillating light emitted by the scintillation material 111, based on wavelengths of light derived from the scintillating light emitted by the scintillation material 111, or a combination thereof. In a particular embodiment, the photosensor 101 can be configured to detect scintillating light or derivative light having an emission maximum of at least approximately 500 nm. In an alternative embodiment, the scintillation material 111 or a particular optical filter material can be included in the neutron detection apparatus 100 to produce scintillating light or a derivate thereof having an emission maximum that corresponds to wavelengths that match the sensitivities of the photosensor 101.

Electrical pulses produced by the photosensor 101 in response to sensing scintillating light can be shaped, digitized, analyzed, or any combination thereof, by the electronics 115 to provide a count of the photons received at the photosensor 101 or other information. In a particular embodiment, the electronics 115 can differentiate photons emitted in response to interactions with gamma rays from photons emitted in response to interactions with neutrons. In an illustrative embodiment, the electronics can utilize a pulse-shape discrimination method, an energy discrimination method, another suitable method, or a combination thereof, to differentiate signals associated with gamma rays from signals associated with neutrons. The electronics 115 can include an amplifier, a pre-amplifier, a discriminator, an analog-to-digital signal converter, a photon counter, another electronic component, or any combination thereof. The photosensor 101 can be housed within a tube or housing made of a material capable of protecting the photosensor 101, the electronics 115, or a combination thereof, such as a metal, a metal alloy, other material, or any combination thereof.

Although, the scintillation material 111 is described with respect to the illustrative embodiment of FIG. 1 as part of the neutron detection apparatus 100, in an embodiment, the scintillation material 111 can also be used in another type of radiation detection apparatus, such as an X-ray detection apparatus. In another embodiment, the scintillation material 111 can be included in a phoswich. For example, the scintillation material 111 can be included in the phoswich along with a gamma ray detection material or an X-ray detection material. In one particular embodiment, the scintillation material 111 can have a suitable thickness to be configured as a neutron shield of a phoswich.

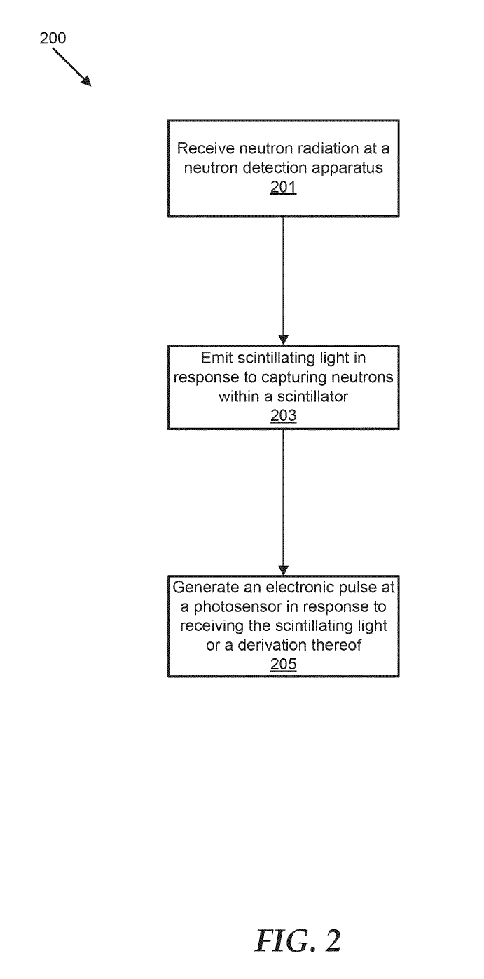

FIG. 2 is a diagram illustrating a process 200 to detect neutrons with a scintillation material. At 201, a neutron detection apparatus receives neutron radiation. In an embodiment, the neutron radiation can be produced by a neutron source. The neutron radiation can include a number of neutrons. The neutron source can include a nuclear reactor, a well logging apparatus, or materials at a point of entry. In one embodiment, the neutron detection apparatus can include a neutron moderator to convert fast neutrons received from the neutron source to thermal neutrons before reaching the scintillator. In an illustrative embodiment, the neutron detection apparatus can comprise the neutron detection apparatus 100 of FIG. 1.

At 203, scintillating light is emitted by a scintillator in response to capturing neutrons within the scintillator. The scintillator can have a composition such that the scintillator emits scintillating light when receiving a target radiation (e.g. neutron radiation). In a particular embodiment, the scintillator can include a gadolinium yttrium aluminum garnet having the formula of Gd₃₍₁₋ₓ₎Y₃ₓAl_{5(1-y)}Ga_{5y}O₁₂, where x is at least approximately 0.05 and no greater than approximately 0.5 and y is at least approximately 0.05 and no greater than approximately 0.95. In an embodiment, the scintillator can be the same as the scintillator of the scintillation material 111 of FIG. 1. The scintillating light can include a number of photons and can have one or more emission maxima. For example, the scintillating light can have an emission maximum within a range of at least approximately 350 nm and no greater than approximately 700 nm.

In one embodiment, the scintillating light can be emitted in response to interactions between secondary particles and the scintillator. For example, the neutron detection apparatus can include a neutron sensing material that produces secondary particles in response to interactions with neutrons. The interactions between the neutrons and the neutron sensing material can include neutron capture, neutron absorption, or a combination thereof. In addition, the secondary particles can include an alpha particle, a triton particle, a deuteron particle, an electron, or any combination thereof. In a particular embodiment, the neutron sensing material can be Gd. In an illustrative embodiment, the neutron sensing material can include ¹⁵⁵Gd, ¹⁵⁷Gd, or both. When a thermal neutron interacts with the ¹⁵⁵Gd or the ¹⁵⁷Gd, conversion electrons having an energy of approximately 70 keV are produced in addition to gamma rays.

In an embodiment, the neutron sensing material can be part of the scintillator of the neutron detection apparatus. In an alternative embodiment, the neutron sensing material can be separate from the scintillator.

In another alternative embodiment, the neutron detection apparatus can include ⁶Li, ¹⁰B, another suitable neutron sensing material, or a combination thereof. In an embodiment, the ⁶Li, ¹⁰B, or other suitable neutron sensing material, can be included in the neutron detection apparatus in addition to the ¹⁵⁷Gd. In a particular embodiment, the additional neutron sensing material can be disposed separate from the ¹⁵⁷Gd in the neutron detection apparatus, such as in a layer separate from the scintillator.

At 205, an electronic pulse is generated at a photosensor in response to receiving the scintillating light. In another embodiment, the photosensor can generate an electronic pulse in response to receiving a derivation of the scintillating light. For example, the neutron detection apparatus can include a wavelength shifter to shift the wavelength of the photons of the scintillating light to a longer wavelength and produce a derivative of the scintillating light. In another example, the derivative of the scintillating light can be produced by an optical filter that inhibits the passage of certain wavelengths of radiation and allows other wavelengths of radiation to pass through. The neutron detection apparatus can also include electronics to analyze the electrical pulses produced by the photosensor. For example, the electronics can be configured to utilize pulse-shape discrimination to differentiate gamma rays captured by the scintillator from neutrons captured by the scintillator.

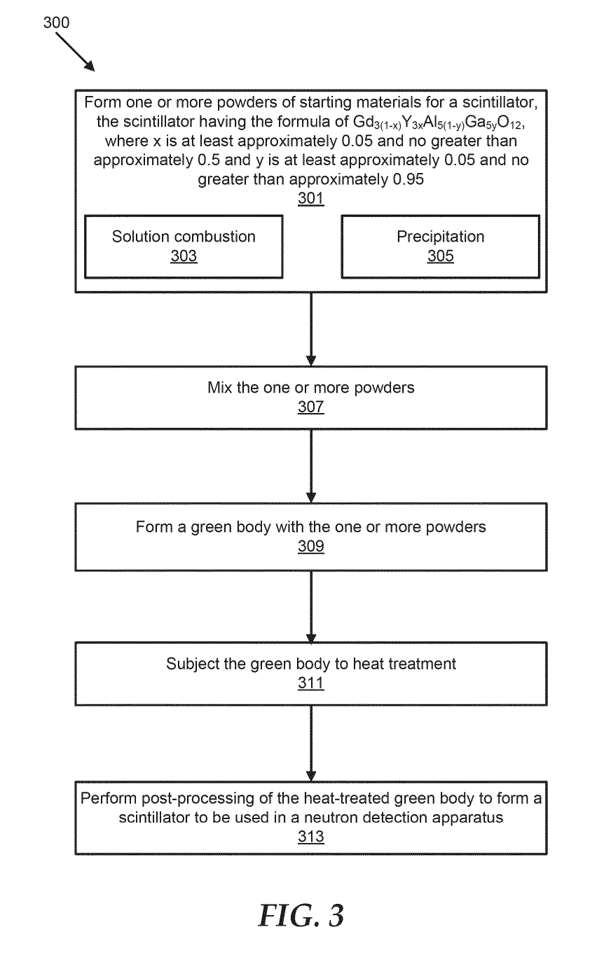

FIG. 3 is a flow diagram illustrating a process 300 to make a scintillator according to an embodiment. The scintillator can have the formula Gd₃₍₁₋ₓ₎Y₃ₓAl_{5(1-y)}Ga_{5y}O₁₂, where x is at least approximately 0.05 and no greater than approximately 0.5 and y is at least approximately 0.05 and no greater than approximately 0.95. The scintillator can be capable of emitting scintillating light in response to interactions with neutrons, in response to interactions with secondary particles produced by neutrons, or a combination thereof.

At 301, the process 300 can include forming one or more powders of starting materials. At 303, a powder of the starting materials can be produced through a solution combustion process. In a particular embodiment, a powder corresponding to the formula Gd₃₍₁₋ₓ₎Y₃ₓAl_{5(1-y)}Ga_{5y}O₁₂, can be produced via a solution combustion process. In an additional embodiment, a Ga₂O₃ powder can be produced via a solution combustion process. The solution combustion process can include an exothermic reaction of a mixture that includes one or more oxidizers, an organic fuel, and water. In an embodiment, the one or more oxidizers can include metal nitrates, ammonium nitrate, ammonium perchlorate, or any combination thereof. The fuel can include urea (CH₄N₂O), carbohydrazide (CH₆N₄), glycine (C₂H₅NO₂), or a combination thereof. In a particular embodiment, the solution combustion reaction can be initiated at a temperature no greater than approximately 500° C. A muffle furnace or a hot plate can be used to heat the mixture to the combustion reaction initiation temperature. The mixture can be heated for at least approximately 15 seconds, at least approximately 1 minute, or at least approximately 3 minutes before the combustion reaction takes place. In another embodiment, the mixture may be heated for no greater than approximately 15 minutes, no greater than approximately 7 minutes, no greater than approximately 5 minutes or no greater than approximately 2 minutes before the solution combustion reaction occurs.

At 305, powders of the starting materials can be produced via a precipitation process. For example, one or more Ga₂O₃ powders can be formed from a precipitation process. In one embodiment, a Ga₂O₃ powder can be formed by precipitation using an ammonia water solution. In another embodiment, a Ga₂O₃ powder can be formed by precipitation using an ammonium hydrogen carbonate solution. In a further embodiment, a (Gd, Y)₂O₃:Ce powder can be produced via a co-precipitation process.

The starting materials can also include one or more additional powders, such as an Al₂O₃ powder. In addition, the starting materials include an activator, such as Ce. In another embodiment, the starting material can include a sintering aid (e.g. tetraethyl orthosilicate), other additives, or a combination thereof.

In an embodiment, particles of the powders of the starting materials can have a D10 value of at least approximately 0.065 micrometers, at least approximately 0.140 micrometers, at least approximately 0.225 micrometers, or at least approximately 0.310 micrometers. In another embodiment, the D10 value for particles of the powders of the starting materials may be no greater than approximately 0.600 micrometers, no greater than approximately 0.460 micrometers, or no greater than approximately 0.380 micrometers. Additionally, the particles of the powders of the starting materials can have a D50 value of at least approximately 0.10 micrometers, at least approximately 0.55 micrometers, at least approximately 0.90 micrometers, or at least approximately 1.30 micrometers. The D50 value for the particles of the powders of the starting materials may also be no greater than approximately 1.73 micrometers, no greater than approximately 1.40 micrometers, or no greater than approximately 1.15 micrometers. In a further embodiment, the particles of the powders of the starting materials can have a D90 value of at least approximately 0.180 micrometers, at least approximately 0.95 micrometers, at least approximately 1.40 micrometers, or at least approximately 2.90 micrometers. The D90 value for the particles of the powders of the starting materials may also be no greater than approximately 4.80 micrometers, no greater than approximately 3.90 micrometers, or no greater than approximately 3.10 micrometers. In an additional embodiment, the specific surface area for particles of the powders of the starting materials can be at least approximately 7.0 m²/g, at least approximately 13.1 m²/g, or at least approximately 18.4 m²/g. The specific surface area for the particles of the powders of the starting materials may also be no greater than approximately 21.9 m²/g, no greater than approximately 19.4 m²/g, or no greater than approximately 17.7 m²/g.

At 307, the starting materials can be mixed, such as via ball milling. In a particular embodiment, the powders of the starting materials can be weighed before being mixed.

At 309, the mixture can be formed into a green body, such as via cold die pressing, cold isostatic pressing, or a combination thereof. During cold isostatic pressing, the mixture can be pressed at pressures within a range of approximately 180 MPa to approximately 220 MPa.

At 311, the green body can be subjected to one or more heat treatments, such as sintering, hot isostatic pressing, or a combination thereof. In one embodiment, the green body can undergo a vacuum sintering process at a temperature within a range of approximately 1700° C. to approximately 1750° C. for a duration within a range of approximately 4 hours to approximately 12 hours. The vacuum sintering can take place at pressures within a range of approximately 10⁻⁴ Pa to approximately 10⁻³ Pa. In another embodiment, the green body can be subjected to hot isostatic pressing at a temperature within a range of approximately 1300° C. to approximately 1500° C. at a pressure within a range of approximately 50 MPa to approximately 100 MPa.

At 313, after heat treatment, the green body can undergo one or more post-processing operations, such as drying, curing, shaping, or a combination thereof, to form a scintillator to be used in a neutron detection apparatus, such as the neutron detection apparatus 100 of FIG. 1.

The scintillators formed as described herein include an amount of ¹⁵⁷Gd that acts as a neutron sensing material and is involved in the emission of scintillating light. Thus, a neutron detection apparatus including the scintillators formed according to embodiments described herein can provide improved efficiency in the detection of neutrons due to the increased content of neutron sensing material (i.e. ¹⁵⁷Gd) relative to previous neutron detection apparatuses. Furthermore, utilizing a neutron sensing material in a scintillator of a neutron detection apparatus reduces the cost of producing the neutron detection apparatus because the neutron detection apparatus does not include separate scintillators and neutron sensing materials. In addition, the scintillators formed as described herein can have improved detection of neutrons due to a light output on the order of approximately 50,000 photons/MeV, a decay time in the range of approximately 50-60 ns, and an energy resolution less than 5% at 662 keV.

### EXAMPLES

The concepts described herein will be further described in the following examples, which do not limit the scope of the invention described in the claims. Numerical values in this Examples section may be approximated or rounded off for convenience.

Scintillators are prepared using the processes described previously. In particular, scintillators are prepared using powders of (Gd_{0.5}, Y_{0.5})₂O₃:Ce, Al₂O₃, and Ga₂O₃. Characteristics of the particles of the powders are included in Table 1. The (Gd_{0.5}, Y_{0.5})₂O₃:Ce and Ga₂O₃ powders are prepared by a precipitation process. Specifically, the Ga₂O₃ AW powder is produced from precipitating an ammonia water (AW) solution into a solution of Ga(NO₃)₃ and GaCl₃ and the Ga₂O₃ (AHC) powder is formed by precipitating a solution of Ga(NO₃)₃ and GaCl₃ into an ammonium hydrogen carbonate solution. The Ga(NO₃)₃ solution and the GaCl₃ solution are produced from dissolving metal Ga in aqua regia. The aqua regia is a mixture of nitric acid and hydrochloric acid. The Ga₂O₃ (AW) and the Ga₂O₃ (AHC) powders are calcined for a duration within a range of approximately 1.8 hours and approximately 2.2 hours at a temperature within a range of approximately 930° C. to approximately 970° C.

The (Gd_{0.5}, Y_{0.5})₂O₃:Ce powder is formed via a co-precipitation process. The co-precipitation process includes combining an amount of a precipitant, such as an ammonia water solution or an ammonium hydrogen carbonate solution, with a mixture of Y(NO₃)₃, Gd(NO₃)₃, and Ce(NO₃)₃ to form a precipitate precursor solution. The precipitate precursor solution is then filtered to form a wet cake and subsequently dried. The (Gd_{0.5}, Y_{0.5})₂O₃:Cewet cake is calcined for a duration within a range of approximately 1.8 hours and approximately 2.2 hours at a temperature within a range of approximately 930° C. to approximately 970° C.

TABLE 1

| | D10 | D50 | D90 | Specific Surface Area |
|---|---|---|---|---|
| Powder | (μm) | (μm) | (μm) | (m2/g) |
| (Gd_{0.5}, Y_{0.5})₂O₃ | 0.079 | 0.14 | 1.36 | 18.57 |
| Al₂O₃ | 0.113 | 0.15 | 0.202 | 21.0 |
| Ga₂O₃ (AW) | 0.487 | 0.825 | 1.365 | 8.58 |
| Ga₂O₃ (AHC) | 0.144 | 1.54 | 4.54 | 20.28 |

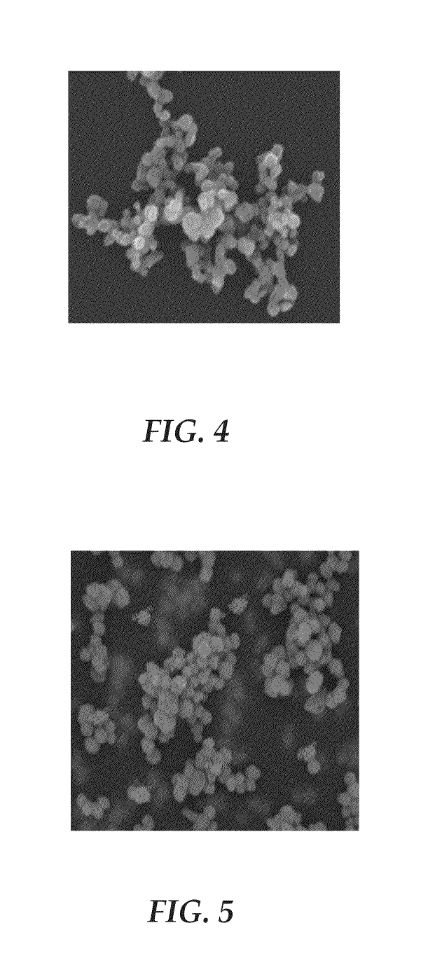

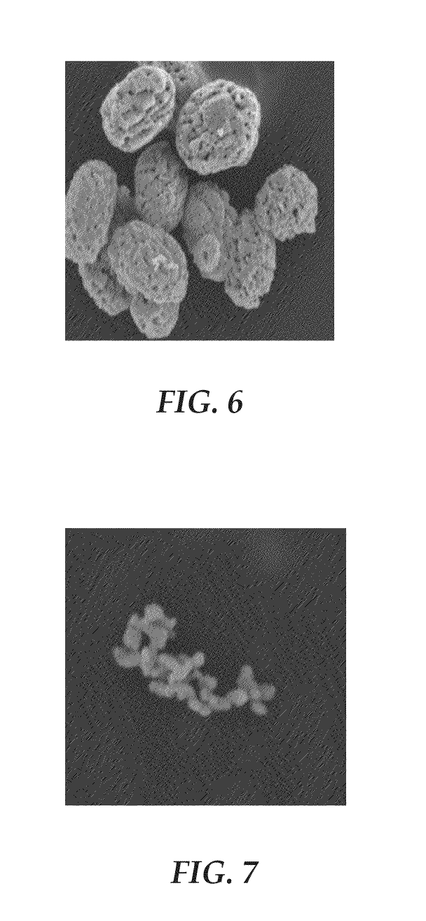

FIGS. 4 to 7 are scanning electron microscope (SEM) images of powders used to form scintillators as described in embodiments herein. In particular, FIG. 4 is a scanning electron microscope (SEM) image of a (Gd_{0.5}, Y_{0.5})₂O₃ powder, FIG. 5 is an SEM image of an Al₂O₃ powder, FIG. 6 is an SEM image of a Ga₂O₃ (AW) powder, and FIG. 7 is an SEM image of a Ga₂O₃ (AHC) powder.

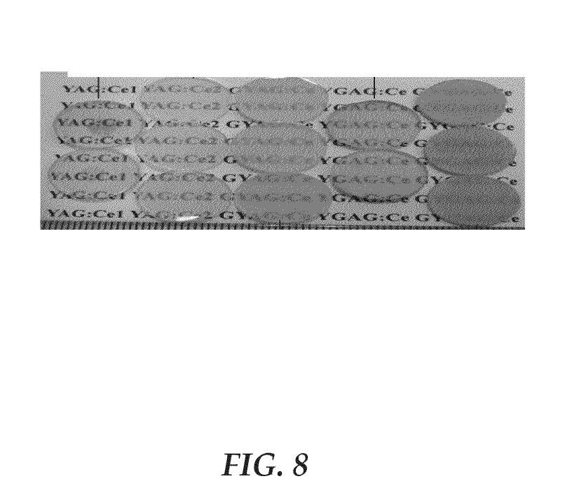

The powders are weighed in amounts to form a scintillator having a particular composition and the powders are then mixed via planetary milling. Subsequently, the mixture of powders is formed into a green body using a cold isostatic pressing process at pressures within a range of approximately 180 MPa to approximately 220 MPa. After cold isostatic pressing, some samples are formed through a vacuum sintering process at a temperature within a range of approximately 1700° C. to approximately 1750° C. for a duration within a range of approximately 4 hours to approximately 12 hours and at pressures within a range of approximately 10⁻⁴ Pa to approximately 10⁻³ Pa. Other samples are formed through hot isostatic pressing at a temperature within a range of approximately 1300° C. to approximately 1500° C. at a pressure within a range of approximately 50 MPa to approximately 100 MPa. FIG. 8 is an image of a number of samples of a scintillator having the formula Gd₃₍₁₋ₓ₎Y₃ₓAl_{5(1-y)}Ga_{5y}O₁₂:Ce.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A neutron detection apparatus, comprising:
a scintillator having a formula of Gd₃₍₁₋ₓ₎Y₃ₓAl_{5(1-y)}Ga_{5y}O₁₂, wherein x is at least 0.05 and no greater than 0.5 and y is at least 0.05 and no greater than 0.95, wherein the scintillator is capable of emitting scintillating light in response to interactions with neutrons; and
a photosensor optically coupled to the scintillator.

2. The neutron detection apparatus as recited in claim 1, wherein x is at least 0.09-and no greater than 0.44.

3. The neutron detection apparatus as recited in claim 1, wherein y is at least 0.15 and no greater than 0.85.

4. The neutron detection apparatus as recited in claim 1, wherein the scintillator comprises an activator including Ce, Pr, Tb, or a combination thereof.

5. The neutron detection apparatus as recited in claim 4, wherein the scintillator includes at least 100 atomic parts per million (ppm) Ce and no greater than 1.5 atomic % Ce.

6. The neutron detection apparatus as recited in claim 4, wherein the activator is substituted for part of Gd, part of Y, or both part of Gd and Y.

7. The neutron detection apparatus as recited in claim 1, wherein the neutron detection apparatus further comprises an optical coupling material disposed between the scintillator and the photosensor.

8. The neutron detection apparatus as recited in claim 1, wherein the neutron detection apparatus comprises a neutron moderator to convert fast neutrons to thermal neutrons.

9. The neutron detection apparatus as recited in claim 1, wherein the neutron detection apparatus comprises a wavelength shifter to shift a wavelength of the scintillating light to a derivative light that has a longer wavelength as compared to the wavelength of the scintillating light.

10. The neutron detection apparatus as recited in claim 1, wherein the neutron detection apparatus comprises a plurality of layers comprising the scintillator.

11. The neutron detection apparatus as recited in claim 1, wherein the scintillating light has an emission maximum that is at least 350 nm and no greater than 710 nm.

12. The neutron detection apparatus as recited in claim 1, wherein the scintillator has a porosity that is no greater than 10 vol %.

13. The neutron detection apparatus as recited in claim 1, wherein the photosensor has a quantum efficiency of at least 8%.

14. The neutron detection apparatus as recited in claim 1, wherein the scintillator includes a plurality of phases.

15. The neutron detection apparatus as recited in claim 14, wherein the plurality of phases includes a ceramic phase and at least one non-crystalline secondary phase.

16. The neutron detection apparatus as recited in claim 15, wherein the at least one secondary phase includes an amorphous phase.

17. The neutron detection apparatus as recited in any one of claim 1, wherein the scintillator includes a single phase.

18. A process comprising:
forming one or more powders of starting materials;
mixing the one or more starting materials to form a mixture;
forming the mixture into a green body; and
heat treating the green body to form a scintillator having a formula of Gd₃₍₁₋ₓ₎Y₃ₓAl_{5(1-y)}Ga_{5y}O₁₂, wherein x is at least 0.05 and no greater than 0.5 and y is at least 0.05 and no greater than 0.95, and wherein the scintillator is capable of emitting scintillating light in response to interactions with neutrons.

19. The process as recited in claim 18, wherein particles of the one or more powders of the starting materials have a specific surface area of at least 7.0 m²/g and no greater than 21.9 m²/g.

20. An X-ray detection apparatus, comprising:
a scintillator having a formula of Gd₃₍₁₋ₓ₎Y₃ₓAl_{5(1-y)}Ga_{5y}O₁₂, wherein x is at least 0.05 and no greater than 0.5 and y is at least 0.05 and no greater than 0.95, wherein the scintillator is capable of emitting scintillating light in response to interactions with X-rays; and
a photosensor optically coupled to the scintillator.
